(19) United States
(12) Patent Application Publication
(10) Pub. No.: US 2010/0161375 A1
(43) Pub. Date: Jun. 24, 2010

(54) System and Method of Presenting an Asset Bundle Offer

(75) Inventors: Heather Lloyd, Croton Falls, NY (US); Daniel Malee, Wheaton, IL (US); Satish Baratam, Croton Falls, IL (US); Nancy McMurry, Danville, CA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/339,177

(22) Filed: Dec. 19, 2008

(51) Int. Cl. G06Q 30/00; G06Q 10/00; H04N 7/173; H04M 3/42; G06F 13/00

(52) U.S. Cl. 705/10; 705/26; 725/100; 455/414.2; 725/110; 725/60; 705/14.73

(57) ABSTRACT

A method includes identifying an asset bundle including a plurality of assets of different asset types. The method includes identifying devices that are capable of using the plurality of assets. The devices are associated with a subscriber. The method includes presenting an offer to sell the asset bundle to a first device associated with the subscriber based on asset types of the plurality of assets and based on a device type of the first device.

### FIELD OF THE DISCLOSURE

The present disclosure is generally related to presenting an asset bundle offer.

### BACKGROUND

Video promotions may be displayed at devices such as a mobile phone device, a set-top box device, or a computing device to encourage product purchases by providing information related to goods and services available for purchase. However, such promotions do not facilitate sales transactions.

### BRIEF DESCRIPTION OF THE DRAWINGS

FIG. 1 is a block diagram of a first particular embodiment of a system to present an asset bundle offer;

FIG. 2 is a block diagram of a second particular embodiment of a system to present an asset bundle offer;

FIG. 3 is a flow diagram of a first particular embodiment of a method to present an asset bundle offer;

FIG. 4 is a flow diagram of a second particular embodiment of a method to present an asset bundle offer; and

FIG. 5 is a block diagram of an illustrative embodiment of a general computer system.

### DETAILED DESCRIPTION

In a particular embodiment, a computer-readable storage medium includes operational instructions that, when executed by a processor, cause the processor to identify an asset bundle including a plurality of assets of different asset types. The computer-readable storage medium includes operational instructions that, when executed by the processor, cause the processor to identify devices that are capable of using the plurality of assets. The devices are associated with a subscriber. The computer-readable storage medium also includes operational instructions that, when executed by the processor, cause the processor to present an offer to sell the asset bundle to a first device associated with the subscriber based on asset types of the plurality of assets and based on a device type of the first device.

In another particular embodiment, a system includes a bundling module operable to identify, based at least partially on subscriber data, an asset bundle including assets of different asset types. The asset bundle is available for purchase via a single transaction. The system includes a selection module operable to select a subscriber based at least partially on the subscriber data and the asset bundle. The system also includes an offer module operable to identify devices associated with the subscriber, to select at least one of the identified devices that is capable of using an asset of the asset bundle, and to send an offer to sell the asset bundle to at least one of the identified devices.

In a particular embodiment, a device includes a network interface configured to receive asset data associated with an asset bundle that includes a plurality of assets of different asset types. The asset data includes an offer to sell the asset bundle to a subscriber of the device. The asset bundle includes a first asset usable at the device and a second asset usable at a second device. The device includes a display interface configured to display information related to the asset data at a display associated with the device. The device also includes a user interface configured to receive a user selection associated with the displayed information and to instruct the network interface to send a purchase confirmation indicating the user selection to an order fulfillment system.

In a particular embodiment, a method includes receiving, at a set-top box device, asset data associated with an asset bundle including a plurality of assets of different asset types. The asset data is received via an internet protocol television (IPTV) network. The asset bundle includes a first asset usable at the set-top box device and a second asset usable at a second device associated with a subscriber of the set-top box device. The method includes displaying the asset data at a display device associated with the set-top box device. The method includes receiving a confirmation of a purchase of the asset bundle and sending the confirmation of the purchase to an order fulfillment system via the IPTV network.

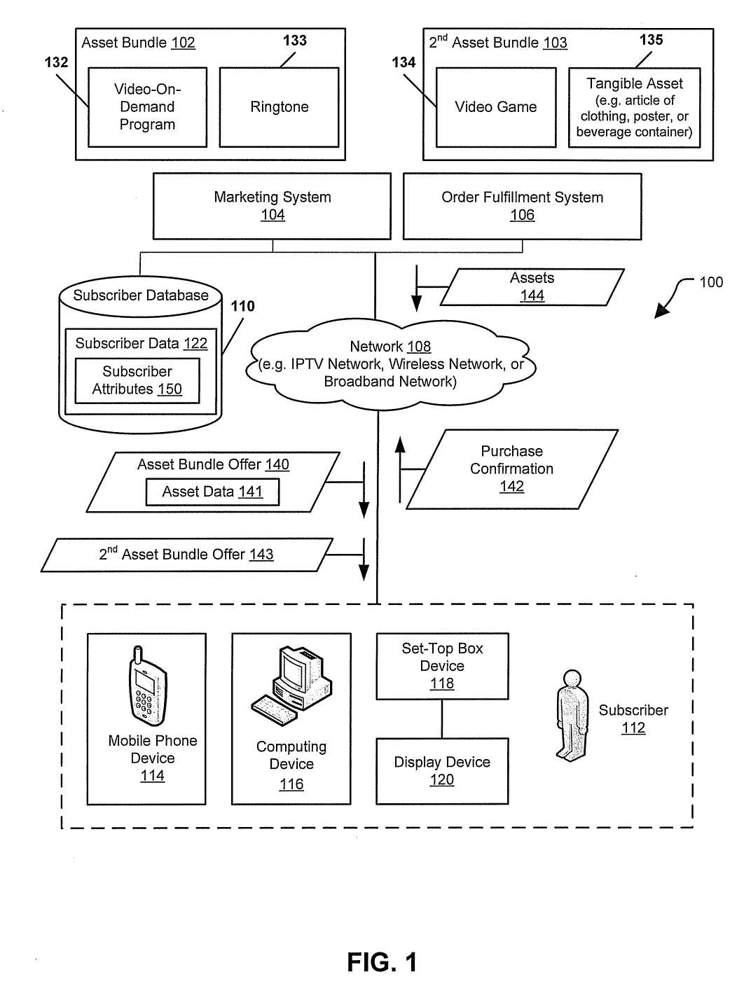

Referring to FIG. 1, a block diagram of a first particular embodiment of a system to present an asset bundle offer is depicted and generally designated 100. The system 100 includes a mobile phone device 114, a computing device 116, and a set-top box device 118 coupled via a network 108 to a marketing system 104 and an order fulfillment system 106. The set-top box device 118, the mobile phone device 114, and the computing device 116 are associated with a subscriber 112. A display device 120 may be coupled to the set-top box device 120.

A subscriber database 110 including subscriber data 122 is coupled to the marketing system 104. The subscriber data 122 includes subscriber attributes 150. For example, the subscriber attributes 150 may include video programs viewed by the subscriber 112, the devices 114-116 associated with the subscriber 112, types of devices associated with the subscriber 112, and address information associated with the subscriber 112. For example, the types of devices associated with the subscriber 112 may include a set-top box device type, a mobile phone device type, and a computing device type.

The marketing system 104 is operable to identify an asset bundle, such as asset bundle 102 or second asset bundle 103. The asset bundles 102 and 103 may include a plurality of assets of different asset types. For example, as illustrated in FIG. 1, the asset bundle 102 includes a video-on-demand program 132 and a ringtone 133. The second asset bundle 103 includes a video game 134 and a tangible asset 135. The asset types of the asset bundles 102 and 103 may include a downloadable asset, such as the ringtone 133 or the video game 134. The asset types of the asset bundles 102 and 103 may include a tangible asset, such as the tangible asset 135. For example, the tangible asset 135 may be an article of clothing, a poster or a beverage container. To illustrate, the tangible asset 135 may be a cap, a shirt, a coffee mug, or other tangible asset.

The marketing system 104 is operable to identify the devices 114, 116, and 118 associated with the subscriber 112 that are capable of using the assets of each of the asset bundles 102 and 103. For example, the marketing system 104 may identify that the mobile phone device 114 is capable of using the ringtone 133, that the computing device 116 is capable of using the video game 134, and that the set-top box device 118 is capable of using the video-on-demand program 132. In a particular embodiment, the marketing system 104 identifies the subscriber 112 based on the subscriber attributes 150 and then identifies the devices 114, 116, and 118 associated with the subscriber 112.

The marketing system 104 is operable to present an asset bundle offer 140 to a first device associated with the subscriber 112 based on asset types of the plurality of assets of the asset bundles 102 and 103 and based on a device type of the first device. For example, the asset bundle offer 140 may include an offer to sell the asset bundle 102 to the set-top box device 118 because the set-top box device 118 has a video device type capable of using the video-on-demand program 132. The asset bundle offer 140 may include an offer to sell the asset bundle 102 to the mobile phone device 114 because the mobile phone device 114 is a phone device type capable of using the ringtone 133. The marketing system 104 is further operable to present a second asset bundle offer 143 at a second device associated with the subscriber 112. The second asset bundle offer 143 may include an offer to sell the second asset bundle 103 that includes the video game 134. For example, the marketing system 104 may present the second asset bundle offer 143 at the computing device 116. The asset bundle offer 140 may be sent to the subscriber 112 when the asset types of the asset bundles 102 and 103 are supported by at least one device type of the devices 114, 116 and 118 associated with the subscriber 112.

The order fulfillment system 106 is operable to receive a purchase confirmation 142 from the subscriber 112 and to send assets 144 to one or more of the devices 114, 116, and 118. In a particular embodiment, the marketing system 104 is operable to receive the purchase confirmation 142 and to forward the purchase confirmation 142 to the order fulfillment system 106. When the assets 144 are electronically accessible assets, the order fulfillment system 106 is operable to send the assets 144 to the devices 114, 116, and 118 associated with the subscriber 112. When the subscriber 112 purchases the second asset bundle 103 that includes the tangible asset 135, the order fulfillment system 106 is operable to have the tangible asset 135 delivered at a physical address associated with the subscriber 112. For example, the order fulfillment system 106 may retrieve subscriber data 122 that includes a physical address of the subscriber 112. The tangible asset 135 may be delivered to the physical address of the subscriber 112.

In operation, the marketing system 104 identifies an asset bundle, such as the asset bundles 102 and 103. In a particular embodiment, one of the the asset bundles 102 or 103 is selected by identifying the subscriber data 122 associated with the set-top box device 118, identifying the other devices, such as the mobile phone device 114 and the computing device 116, associated with the set-top box device 118, and selecting assets of the asset bundles 102 and 103 based on the device types of the set-top box device 118 and the device types of the devices 114 and 116. The marketing system 104 identifies subscribers, such as the subscriber 112, based on the subscriber data 122 including the subscriber attributes 150. For example, the marketing system 104 may identify the subscriber 112 based on the type of devices associated with the subscriber 112, the physical address of the subscriber 112, programs viewed by the subscriber 112, other data associated with the subscriber 112, or any combination thereof. In a particular embodiment, the marketing system 104 identifies the devices 114, 116, and 118 associated with the subscriber 112 based on the subscriber data 122. For example, the subscriber data 122 may include a list of the devices 114, 116, and 118 associated with the subscriber 112.

The marketing system 104 identifies an asset bundle that has at least one asset that is capable of being used by one or more of the devices 114, 116, and 118. The marketing system 104 then sends an asset bundle offer 140 to at least one of the devices 114, 116, and 118 via the network 108. The asset bundle offer 140 includes an offer to sell an asset bundle, such as the asset bundles 103 and 103, to the subscriber 112 in a single transaction. The asset bundle 102 includes a first asset (e.g. the video-on-demand program 132) usable at the set-top box device 118. The asset bundle 102 includes a second asset (e.g. the ringtone 133) usable at a second device associated with the subscriber 112 of the set-top box device 118. For example, in the asset bundle 102, the ringtone 133 is usable at the mobile phone device 114 associated with the subscriber 112.

The set-top box device 118 receives the asset data 141 associated with an asset bundle offer 140. The asset data 141 may be displayed at the display device 120 associated with the set-top box device 118. When the subscriber 112 purchases an asset bundle by accepting the asset bundle offer 140, a purchase confirmation 142 indicating a purchase of the asset bundle is sent to the marketing system 104 from the subscriber 112. In a particular embodiment, the marketing system 104 forwards the purchase confirmation 142 to the order fulfillment system 106 via the network 108. In another particular embodiment, the order fulfillment system 106 receives the purchase confirmation 142. When one or more of the assets of the asset bundle are electronically distributable assets, the order fulfillment system 106 sends the assets 144 to one or more of the devices 114, 116, and 118 associated with the subscriber 112. For example, the order fulfillment system 106 may send the electronically distributable asset via the network 108. Alternately, the order fulfillment system 106 may send a link to enable the asset to be downloaded. When one of the assets of the asset bundle is the tangible asset 135, the order fulfillment system 106 retrieves a physical address of the subscriber 112 from the subscriber database 110, and the tangible asset 135 is sent to the physical address of the subscriber 112.

By identifying asset bundles, such as the asset bundles 102 and 103, and identifying subscribers based on subscriber data, the marketing system 104 can target the asset bundles to subscribers having devices that are capable of using the assets of the asset bundles. For example, an asset bundle offer presented at a first device may include an offer to sell an asset bundle that includes an asset usable at a second device.

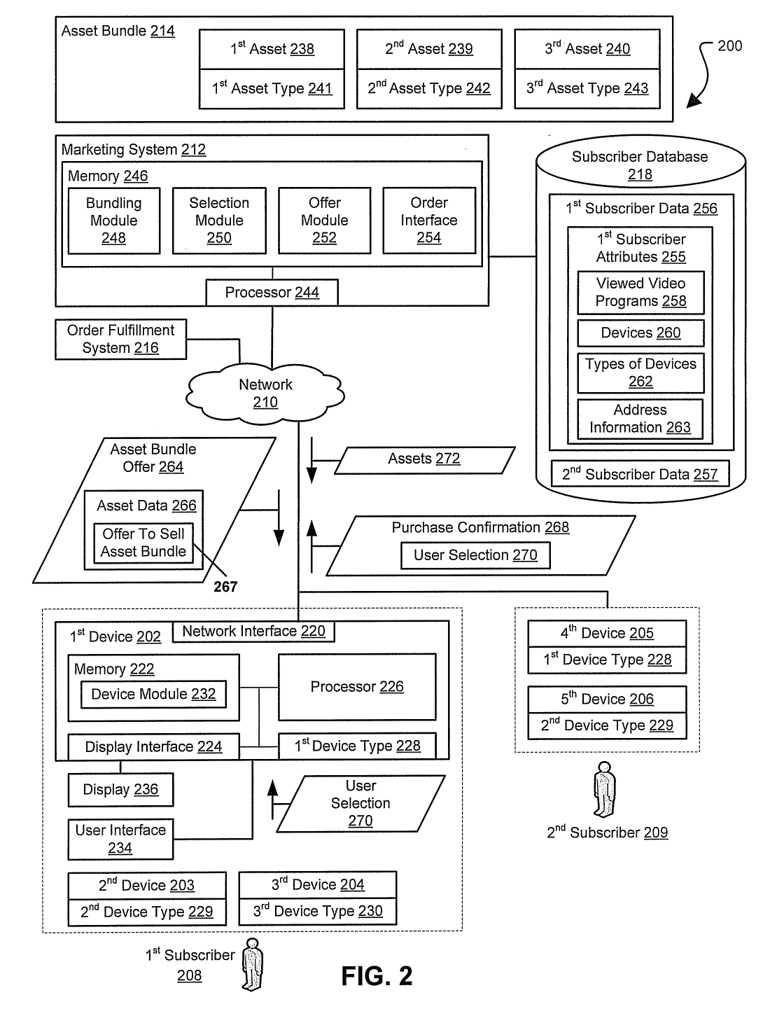

Referring to FIG. 2, a block diagram of a second particular embodiment of a system to present an asset bundle offer is depicted and generally designated 200. The system 200 includes a marketing system 212 and an order fulfillment system 216 coupled to a network 210. A first device 202, a second device 203, a third device 204, a fourth device 205, and a fifth device 206 are coupled to the marketing system 212 via the network 210. The network 210 may be an Internet Protocol Television (IPTV) network, a wireless network, a broadband network, or any combination thereof.

In the embodiment illustrated in FIG. 2, the devices 202, 203 and 204 are associated with a first subscriber 208, and the devices 205 and 206 are associated with a second subscriber 209. The first device 202 has a first device type 228; the second device 203 has a second device type 229; the third device 204 has a third device type 230; the fourth device 205 has the first device type 228; and the fifth device 206 has the second device type 229. In a particular embodiment, the first device type 228 may be a set-top box device type, the second device type 229 may be a mobile phone device type, and the third device type 230 may be a computing device type.

The first device 202 includes a network interface 220, a memory 222, a display interface 224, a processor 226, and a first device type 228. The memory 222 includes a device module 232. A display 236 and a user interface 234 are coupled to the first device 202. The first device 202 is operable to receive an asset bundle offer 264 including asset data 266 from the marketing system 212. In a particular embodiment, the network interface 220 is operable to receive the asset data 266 associated with an asset bundle 214 that includes the plurality of assets 238, 239 and 240 of different asset types 241, 242, and 243. In a particular embodiment, the asset bundle 214 includes the first asset 238 usable at the first device 202 and the second asset 239 usable at the second device 203. The asset data 266 includes an offer to sell the asset bundle 214 to the first subscriber 208 of the first device 202. The display interface 224 is operable to display information related to the asset data 266 at the display 236 associated with the first device 202.

The user interface 234 is operable to receive a user selection 270 associated with the displayed information and to instruct the network interface 220 to send a purchase confirmation 268 indicating the user selection 270 to an order fulfillment system 216 via the network 210. The network interface 220 is further operable to receive one or more of the assets 272 of the asset bundle 214. For example, when the asset is a video game and the first device 202 is a computing device, the network interface 220 may receive the video game via the network 210.

A subscriber database 218 is coupled to the marketing system 212. The subscriber database 218 includes first subscriber data 256 and second subscriber data 257. The first subscriber data 256 includes first subscriber attributes 255, including viewed video programs 258, devices 260, types of devices 262, and address information 263. For example, the viewed video programs 258 may include video programs that a subscriber, such as the first subscriber 208, has viewed at a set-top box device associated with the first subscriber 208. The devices 260 of the subscriber data 256 include devices associated with the first subscriber 208, such as the first device 202, the second device 203 and the third device 204. The address information 263 may include a physical address to which tangible assets may be shipped. Alternatively, the address information 263 may include an electronic device address, such as an Internet Protocol (IP) address, an email address, or a phone number capable of receiving or downloading electronically distributable assets.

The marketing system 212 includes a memory 246 and a processor 244. The memory 246 includes a bundling module 248, a selection module 250, an offer module 252, and an order interface 254. The bundling module 248 is operable to identify, based at least partially on the first subscriber data 256, an asset bundle 214 including assets of different types. For example, the asset bundle 214 includes a first asset 238 having a first asset type 241, a second asset 239 having a second asset type 242, and a third asset 240 having a third asset type 243.

The selection module 250 is operable to select a subscriber based at least partially on the first subscriber data 256 and the asset bundle 214. For example, the selection module 250 may identify the devices 202-204 of the first subscriber 208 based on the subscriber data 256. The selection module 250 may select the first subscriber 208 when the selection module 250 determines that one or more of the devices 202-204 of the first subscriber 208 are capable of using one or more of the assets of the asset bundle 214. The selection module 250 is operable to select the second subscriber 209 based at least partially on the second subscriber data 257 and the asset bundle 214. For example, the selection module 250 may select the second subscriber 209 when one or more of the devices 205 and 206 of the second subscriber 209 are capable of using at least one of the assets of the asset bundle 214.

The offer module 252 is operable to identify devices associated with the subscriber. For example, the offer module 252 is operable to identify the devices 202, 203 and 204 associated with the first subscriber 208 and to identify the fourth device 205 and the fifth device 206 associated with the second subscriber 209. The offer module 252 is operable to select at least one of the identified devices 202-206 that is capable of using an asset of the asset bundle 214 and to send the asset bundle offer 264 to at least one of the identified devices. The asset bundle offer 264 includes an offer to sell the asset bundle 267. The offer module 252 is further operable to send the asset bundle offer 264 to one or more devices 205-206 associated with the second subscriber 209.

The order interface 254 is operable to receive the purchase confirmation 268 of the asset bundle 214 from one of the devices 202-204 associated with the first subscriber 208. For example, the order interface 254 may receive the purchase confirmation 268 of the asset bundle 214 from the first device 202 associated with the first subscriber 208. The order interface 254 is operable to retrieve the first subscriber data 256 associated with the purchase confirmation 268 and to send the purchase confirmation 268 and the subscriber data to the order fulfillment system 216. For example, the order interface 254 may receive the purchase confirmation 268 and determine that the asset bundle 214 includes a tangible asset, retrieve the address information 263, and send the address information 263 to the order fulfillment system 216 to enable the order fulfillment system 216 to send the tangible asset to a physical address of the first subscriber 208.

The order interface 254 is operable to determine the device types 228, 229, and 230 of the devices 202, 203, and 204, respectively, and determine that the asset types 241, 242, 243 of the asset bundle 214 are usable by the devices 202, 203 and 204, respectively. The order interface 254 is operable to male one asset of the asset bundle 214 available to at least one of the devices 202, 203, and 204 that can use the assets 238, 239 and 240. The order interface 254 is operable to make at least one asset of the asset bundle 214 available for download at the second device 203 associated with the first subscriber 208. For example, when the second asset 239 is a ringtone and the second device 203 is a mobile phone device, the order interface 254 makes the second asset 239 available for download at the second device 203. The order interface 254 is operable to retrieve the address information 263 of the first subscriber 208 from the subscriber database 218 and to send a request to the order fulfillment system 216 to send the asset to an address associated with the first subscriber 112. The address information 263 may include an electronic address, such as an electronic mail (e.g. email) address or Internet Protocol (IP) address, a phone number, a physical address, other type of address data, or any combination thereof. For example, the order fulfillment system 216 may send an electronically distributable asset to an electronic address and a tangible asset to a physical address.

In operation, the marketing system 212 retrieves the first subscriber data 256, identifies the asset bundle 214, and sends the asset bundle offer 264 to one or more of the devices 202-204 associated with the first subscriber 208 via the network 210. At least one of the devices 202-204 receives the asset bundle offer 264 and displays the asset data 266. When the first subscriber 208 makes the user selection 270, the purchase confirmation 268 is sent to the order interface 254. The order interface 254 receives the purchase confirmation 268 including the user selection 270 and makes at least one of the assets 238-240 available for download to one of the devices 202-206. For example, the order interface 254 may instruct the order fulfillment system 216 to send the assets 272 to the devices 202-206. When one of the assets 238-240 is a tangible asset, the order interface 254 retrieves the address information 263 and sends a request to the order fulfillment system 216 to send the tangible asset to a physical address of the first subscriber 208.

The marketing system 212 may retrieve the second subscriber data 257 and send the asset bundle offer 264 to one or more of the devices 205-206 associated with the second subscriber 209. When the second subscriber 209 accepts the offer to the sell the asset bundle 267, one of the devices 205 and 206 sends the purchase confirmation 268 to the marketing system 212 or the order fulfillment system 216. The marketing system 212 may make one or more of the assets 238-240 available for download to the devices 205 and 206 associated with the second subscriber 209.

By identifying the first subscriber 208 based on the first subscriber data 256 and identifying the second subscriber 209 based on the second subscriber data 257, the marketing system 104 can target the asset bundle 214 to subscribers having devices that are capable of using the assets 238-240 of the asset bundle 214.

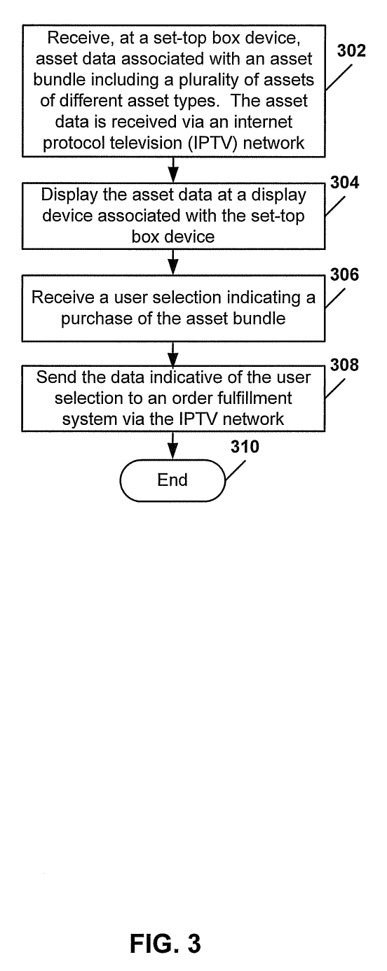

Referring to FIG. 3, a flow diagram of a first particular embodiment of a method to present an asset bundle offer is depicted. The method may be performed by a device, such as the set-top box device 118 of FIG. 1 or the devices 202-206 of FIG. 2.

Asset data associated with an asset bundle is received at a set-top box, at 302. The asset bundle includes a plurality of assets of different asset types. The asset data is received via an Internet Protocol Television (IPTV) network. Continuing to 304, the asset data is displayed at a display device associated with the set-top box device. For example, in FIG. 2, when the first device 202 is a set-top box device, the first device 202 receives the asset data 266 and displays the asset data 266 at the display 236 associated with the first device 202. Moving to 306, a user selection indicating a purchase of the asset bundle is received. For example, in FIG. 2, the user selection 270 is received at the user interface 234 of the first device 202. Advancing to 308, the data indicative of the user selection is sent to an order fulfillment system via the IPTV network. For example, in FIG. 2, the user interface 234 may receive the user selection 270 and send the purchase confirmation 268 (including the user selection 270) to the order fulfillment system 216. The method ends at 310.

Thus, an offer to sell an asset bundle of assets with different asset types may be displayed at one or more devices of a subscriber in order to market the asset bundle to the subscriber. For example, an offer to sell an asset bundle including a video-on-demand program, a ringtone, a video game, and a tangible asset may be presented at one or more devices. For example, the offer to sell the asset bundle may be presented at one or more of a set-top box device, a mobile phone device, and a computing device.

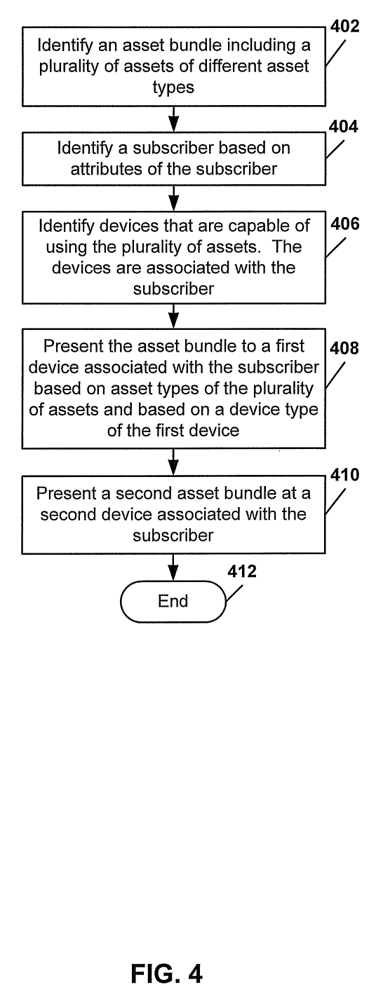

Referring to FIG. 4, a flow diagram of a second particular embodiment of a method to present an asset bundle offer is depicted. The method may be performed by the marketing system 104 of FIG. 1 or the marketing system 212 of FIG. 2.

An asset bundle, including a plurality of assets of different asset types, is identified, at 402. For example, in FIG. 2, the asset bundle 214 including the assets 238-240 is identified. Moving to 404, a subscriber is identified based on attributes of the subscriber. For example, in FIG. 2, attributes of the first subscriber 208 are identified based on the first subscriber attributes 255 stored at the subscriber database 218. Advancing to 406, devices that are capable of using the plurality of assets are identified. The devices are associated with the subscriber. For example, in FIG. 2, the devices 202, 203, and 204 of the first subscriber 208 may be identified based on the first subscriber data 256. Continuing to 408, the asset bundle is presented to a first device associated with the subscriber based on asset types of the plurality of assets and based on a device type of a first device. For example, in FIG. 2, when the first asset 238 is a ringtone and the first device 202 is a mobile phone device, the asset bundle 214 may be presented to the first device 202 because mobile phone device is capable of using the ringtone. Advancing to 410, a second asset bundle is presented at a second device associated with the subscriber. For example, in FIG. 1, the second asset bundle 103 may be presented at the computing device 116 associated with the subscriber 112. The method ends at 412.

By presenting an offer to purchase an asset bundle including a plurality of assets of different asset types, multiple assets may be made available for purchase at a number of devices associated with a subscriber, thereby enhancing sales of the assets. For example, an offer to sell an asset bundle including a ringtone, a video-on-demand program, and a video game may be presented at one or more of a mobile phone device, a set-top box device, and a computing device.

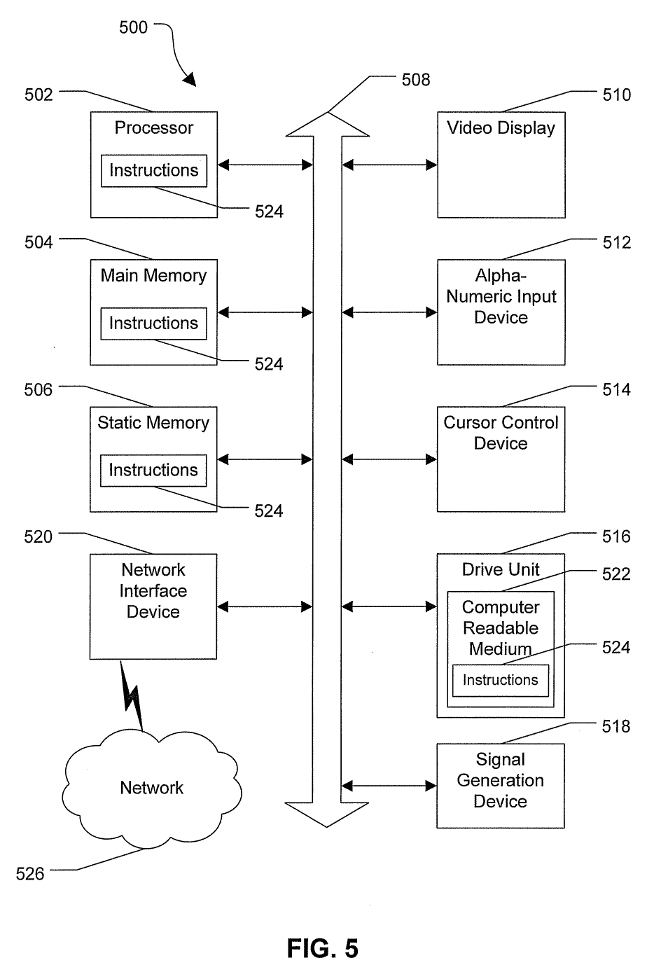

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500, or any portion thereof, may operate as a standalone device or may be connected, e.g., using a network, to other computer systems or peripheral devices, including a subscriber database, a set-top box device, a marketing system, and an order fulfillment system.

In a networked deployment, the computer system may operate in the capacity of a server, such as a subscriber database, a set-top box device, a marketing system, or an order fulfillment system. The computer system 500 can also be implemented as or incorporated into various devices, such as a personal computer (PC), a tablet PC, a set-top box (STB) device, a personal digital assistant (PDA), a mobile device, a palmtop computer, a laptop computer, a desktop computer, a communications device, a wireless telephone, a land-line telephone, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics-processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid-state display, or a projection display. Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other network transmission (e.g., TCP/IP, UDP/IP, HTML, HTTP, SMPTE, MPEG, H.264, GSM, UMTS, CDMA, 1XRTT, DOCSIS, IPTV) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-readable storage medium comprising operational instructions that, when executed by a processor, cause the processor to:
identify an asset bundle including a plurality of assets of different asset types;
identify devices that are capable of using the plurality of assets, the devices associated with a subscriber; and
present an offer to sell the asset bundle to a first device associated with the subscriber based on asset types of the plurality of assets and based on a device type of the first device.

2. The computer-readable storage medium of claim 1, wherein each of the asset types of the asset bundle is supported by at least one device type of the devices associated with the subscriber.

3. The computer-readable storage medium of claim 1, wherein identifying the devices that are capable of using the plurality of assets of the asset bundle further comprises operational instructions that, when executed by the processor, cause the processor to:
identify the subscriber based on attributes of the subscriber; and
identify devices associated with the subscriber that are capable of using at least one asset of the asset bundle.

4. The computer-readable storage medium of claim 1, wherein the asset bundle includes a video-on-demand asset and wherein the asset bundle is presented at a set-top box device.

5. The computer-readable storage medium of claim 1, further comprising operational instructions that, when executed by the processor, cause the processor to present a second asset bundle at a second device associated with the subscriber.

6. The computer-readable storage medium of claim 5, wherein the second asset bundle includes a ringtone asset and wherein the second asset bundle is presented at a mobile phone device.

7. The computer-readable storage medium of claim 1, wherein the asset types include a downloadable asset.

8. The computer-readable storage medium of claim 1, wherein the asset types include a tangible asset.

9. The computer-readable storage medium of claim 8, wherein the tangible asset is at least one of an article of clothing, a poster, and a beverage container.

10. A system, comprising:
a bundling module operable to identify, based at least partially on subscriber data, an asset bundle including assets of different asset types, the asset bundle available for purchase via a single transaction;
a selection module operable to select a subscriber based at least partially on the subscriber data and the asset bundle; and
an offer module operable to identify devices associated with the subscriber, to select at least one of the identified devices that is capable of using an asset of the asset bundle, and to send an offer to sell the asset bundle to at least one of the identified devices.

11. The system of claim 10, wherein the selection module is further operable to select a second subscriber based at least partially on second subscriber data and the asset bundle and wherein the offer module is further operable to send the offer to sell the asset bundle to one or more devices associated with the second subscriber.

12. The system of claim 10, further comprising an order interface operable to receive a purchase confirmation of the asset bundle from one of the devices associated with the subscriber, to retrieve the subscriber data associated with the purchase confirmation, and to send the purchase confirmation and the subscriber data to an order fulfillment system.

13. The system of claim 11, wherein the order interface is further operable to determine device types of each of the devices associated with the subscriber, to determine asset types usable by each of the devices, and to make assets of the bundle available to devices that can use the assets.

14. The system of claim 12, wherein the order interface receives the purchase confirmation of the asset bundle from a first device associated with the subscriber and makes at least one asset of the asset bundle available for download at a second device associated with the subscriber.

15. The system of claim 10, wherein the asset bundle includes a tangible asset and wherein the order interface is further operable to retrieve an address of the subscriber from a subscriber database and to send a request to an order fulfillment system to send the tangible asset to the address of the subscriber.

16. The system of claim 10, wherein the subscriber data includes devices associated with the subscriber.

17. The system of claim 10, wherein the subscriber data includes types of devices associated with the subscriber.

18. A device, comprising:
a network interface configured to receive asset data associated with an asset bundle that includes a plurality of assets of different asset types, the asset data including an offer to sell the asset bundle to a subscriber of the device, wherein the asset bundle includes a first asset usable at the device and a second asset usable at a second device;
a display interface configured to display information related to the asset data at a display associated with the device; and
a user interface configured to receive a user selection associated with the displayed information and to instruct the network interface to send a purchase confirmation indicating the user selection to an order fulfillment system.

19. The device of claim 18, wherein the network interface is further configured to receive one or more of the assets of the asset bundle.

20. The device of claim 18, wherein the device is a computing device and wherein the asset is a video game.

21. A method, comprising:
receiving, at a set-top box device, asset data associated with an asset bundle including a plurality of assets of different asset types, the asset data received via an internet protocol television (IPTV) network, wherein the asset bundle includes a first asset usable at the set-top box device and a second asset usable at a second device associated with a subscriber of the set-top box device;
displaying the asset data at a display device associated with the set-top box device;
receiving a confirmation of a purchase of the asset bundle; and
sending the confirmation of the purchase to an order fulfillment system via the IPTV network.

22. The method of claim 21, further comprising receiving the second asset at the second device.

23. The method of claim 21, wherein the asset bundle is selected before the set-top box device receives the asset data.

24. The method of claim 23, wherein selecting the asset bundle comprises:
identifying subscriber data associated with the set-top box device;
identifying other devices based on the subscriber data;
selecting assets of the asset bundle based on a device type of the set-top box device and the device type of the other devices.
